(19) United States
(12) Patent Application Publication
(10) Pub. No.: US 2020/0098031 A1
(43) Pub. Date: Mar. 26, 2020

(54) PRODUCT RECOMMENDING APPARATUS AND NON-TRANSITORY COMPUTER READABLE MEDIUM

(71) Applicant: FUJI XEROX CO., LTD., Tokyo (JP)

(72) Inventors: Masahiro SATO, Kanagawa (JP); Takashi SONODA, Kanagawa (JP)

(73) Assignee: FUJI XEROX CO., LTD., Tokyo (JP)

(21) Appl. No.: 16/373,644

(22) Filed: Apr. 3, 2019

(30) Foreign Application Priority Data
Sep. 21, 2018 (JP) 2018-176862

(51) Int. Cl. G06Q 30/06; G06F 16/9535

(52) U.S. Cl. CPC G06Q 30/0631; G06F 16/9535

(57) ABSTRACT

A product recommending apparatus includes an obtaining unit, a classification unit, and a controller. The obtaining unit obtains a purchase history indicating information on a product that a user has purchased, and a promotion history indicating information on a product promoted to a user. The classification unit classifies, using the purchase history and the promotion history, each product into one of a first group of items purchased but not promoted, a second group of items purchased and promoted, a third group of items not purchased nor promoted, and a fourth group of items not purchased but promoted. The controller outputs, using a result of classification done by the classification unit, an item that would not be purchased if not promoted but would be purchased if promoted as an item to be recommended to a user.

### CROSS-REFERENCE TO RELATED APPLICATIONS

This application is based on and claims priority under 35 USC 119 from Japanese Patent Application No. 2018-176862 filed Sep. 21, 2018.

### BACKGROUND

### (i) Technical Field

The present disclosure relates to a product recommending apparatus and a non-transitory computer readable medium.

### (ii) Related Art

Japanese Patent No. 5277307 describes an information recommending method capable of making recommendations unexpected to a user. Regarding an unrecommended item, an item that the user has responded with interest and an item to which the user is indifferent are compared to determine with which of the items the unrecommended item has a higher degree of similarity, and the next item to be recommended to the user is determined using the comparison result.

Japanese Unexamined Patent Application Publication No. 2017-211699 describes technology for enhancing the effect of making a recommendation on a product for prompting a consumer to purchase the product, compared with the case of making a recommendation on a product without taking into consideration the degree of effect of making the recommendation on the product. An apparatus based on this technology includes a consumer selecting unit that extracts, from among a plurality of consumers, a consumer whose degree of effect of recommendations in the case of recommending a particular product among products on which recommendations are made in advance to consumers satisfies a predetermined condition, and a product information output unit that recommends the particular product to the extracted consumer.

### SUMMARY

Aspects of non-limiting embodiments of the present disclosure relate to improvement of the accuracy of a to-be-recommended product, compared with the case of learning that equally treats prediction errors of a recommended product and an unrecommended product.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a product recommending apparatus including an obtaining unit, a classification unit, and a controller. The obtaining unit obtains a purchase history indicating information on a product that a user has purchased, and a promotion history indicating information on a product promoted to a user. The classification unit classifies, using the purchase history and the promotion history, each product into one of a first group of items purchased but not promoted, a second group of items purchased and promoted, a third group of items not purchased nor promoted, and a fourth group of items not purchased but promoted. The controller outputs, using a result of classification done by the classification unit, an item that would not be purchased if not promoted but would be purchased if promoted as an item to be recommended to a user.

### BRIEF DESCRIPTION OF THE DRAWINGS

An exemplary embodiment of the present disclosure will be described in detail based on the following figures, wherein:

FIG. 1 is a functional block diagram according to an exemplary embodiment;

FIG. 2 illustrates the degree of preference for products according to the exemplary embodiment;

FIG. 3 illustrates grouping according to the exemplary embodiment;

FIG. 4 is a flowchart of a process of comparative preference learning according to the exemplary embodiment;

FIG. 5 is a flowchart of an overall process according to the exemplary embodiment; and

FIG. 6 illustrates recommended products according to the exemplary embodiment.

### DETAILED DESCRIPTION

Hereinafter, an exemplary embodiment of the present disclosure will be described on the basis of the drawings while treating products as items.

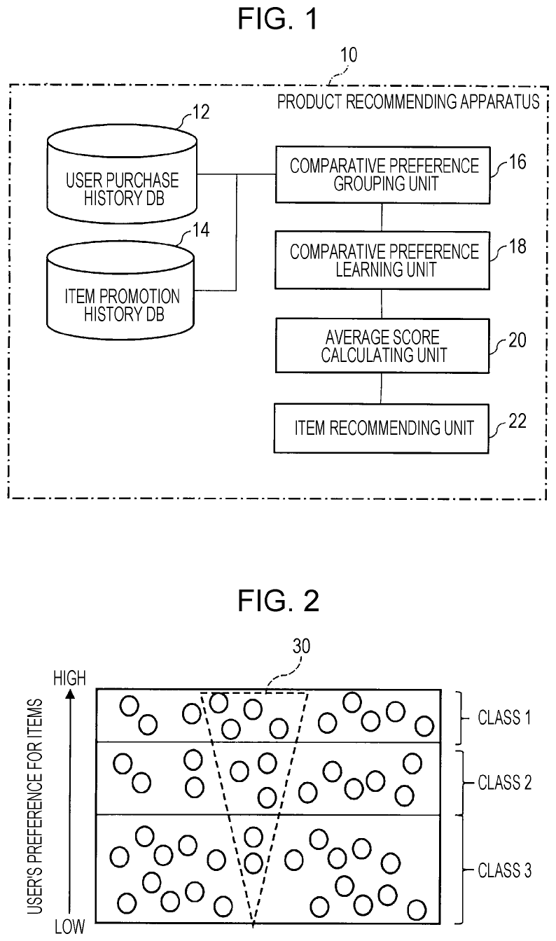

FIG. 1 is a functional block diagram of a product recommending apparatus 10 according to the present exemplary embodiment. The product recommending apparatus 10 includes, as functional blocks, a user purchase history database (DB) 12, an item promotion history DB 14, a comparative preference grouping unit 16, a comparative preference learning unit 18, an average score calculating unit 20, and an item recommending unit 22.

The user purchase history DB 12 stores an item purchase history for each user. As the purchase history, the name of an item, whether or not the user has purchased the item, the place and date of purchase of the item, and so forth may be stored.

The item promotion history DB 14 stores a promotion history for each user and for each item. As the promotion history, the name of an item, whether or not the item has been promoted, whether or not the user is a user to whom the item been promoted in the case where the item has been promoted, the place and date of promotion, and so forth may be stored. Promotions include, distribution of advertisements at stores, posting of advertisements on web sites on the Internet, posting of advertisements on social networking services (SNS), discounted items, and posting of advertisements in noticeable places such as the front page of a catalog. In the case where an item has been promoted to an unspecified number of users, it may be regarded that the item has been promoted to all users. In addition, in the case where an item has been promoted by issuing a coupon to a specific user, it is regarded that the item has been promoted to that user.

The comparative preference grouping unit 16 classifies, using the user purchase histories stored in the user purchase history DB 12 and the promotion histories stored in the item promotion history DB 14, items into a plurality of groups having different degrees of preference according to each user. In the present exemplary embodiment, an item is classified into one of four groups having different degrees of preference according to each user. These four groups are identified by a combination of the presence or absence of promotion and the presence or absence of purchase. That is, (two combinations of the presence or absence of promotion)×(two combinations of the presence or absence of purchase)=four groups.

The comparative preference learning unit 18 learns a parameter of a model necessary for quantifying the strength of preference of each user for each item by using items that are classified into the four groups. The comparative preference learning unit 18 learns by calculating the probability of, in the case where attention is paid to a certain user, that user's preferring a certain item to another item, and adjusting the parameter so that the probability becomes maximum.

Using the model learned by the comparative preference learning unit 18, the average score calculating unit 20 quantifies the strength of preference of each user for each of the items belonging to the four groups, and calculates the average of strength of preference for the items as a representative value of strength of preference of each group for the items. For example, for a certain user, if vi is a preference score which indicates the strength of preference for item i belonging to a certain one of the four groups, and N is the number of items in that group, then that group's average preference score=(Evi)/N.

The average preference score is calculated for each user and for each group. Therefore, given user u and user v as users, and group A, group B, group C, and group D as groups, then

the following are calculated for user u:
the average preference score of group A;
the average preference score of group B;
the average preference score of group C; and
the average preference score of group D, and
   the following are calculated for user v:
the average preference score of group A;
the average preference score of group B;
the average preference score of group C; and
the average preference score of group D.

Using the average preference score for each user and for each group, calculated by the average score calculating unit 20, the item recommending unit 22 extracts an item to be recommended to the user. The item recommending unit 22 determines whether or not the preference score of an item of interest satisfies a specified condition, and, in the case where the preference score satisfies the specified condition, regards that the item is an item to be recommended.

The product recommending apparatus 10 includes a computer that includes one or more processors, read-only memory (ROM), random-access memory (RAM), an input/output interface, a communication interface, and a storage device such as a hard disk drive (HDD) or a solid state drive (SSD). The processor(s) reads and executes a processing program stored in the ROM or the storage device to realize the comparative preference grouping unit 16, the comparative preference learning unit 18, the average score calculating unit 20, and the item recommending unit 22. The storage device realizes the user purchase history DB 12 and the item promotion history DB 14.

At least one of the user purchase history DB 12, the item promotion history DB 14, the comparative preference grouping unit 16, the comparative preference learning unit 18, the average score calculating unit 20, and the item recommending unit 22 may be realized by a plurality of computers connected to one another by a communication network. An exemplary case is as follows: the user purchase history DB 12 is realized by a certain computer; the item promotion history DB 14 is realized by another computer; and the comparative preference grouping unit 16, the comparative preference learning unit 18, the average score calculating unit 20, and the item recommending unit 22 are realized by yet another computer.

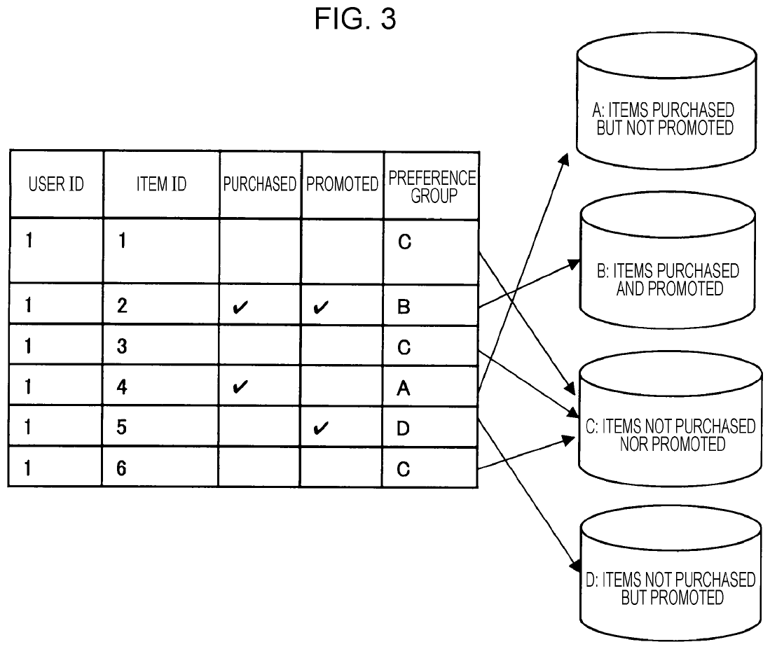

FIG. 2 illustrates the case in which items are classified into three classes according to the level of preference of each user for items. In FIG. 2, the individual circles represent items. In addition, an area 30 indicated by a broken line in FIG. 3 represents a set P of items promoted in the past. Items may be classified into:
class 1: an item that the user purchases even when the item is not promoted;
class 2: an item that the user does not purchase when the item is not promoted, but purchases when the item is promoted; and
class 3: an item that the user does not purchase even when the item is promoted.
   Specifically, an item with a low user's preference is an item that the user does not purchase even when the item is promoted, and is classified into class 3. In addition, an item with a high user's preference is an item that the user voluntarily purchases even when the item is not promoted, and is classified into class 1. An item with an intermediate user's preference is classified into class 2 since whether the user purchases this item or not is determined by whether the item is promoted or not.

In contrast, an item is either a promoted item or an unpromoted item. Thus, items are classified into the following four groups when attention is paid to the actual purchase history:
group A: an item purchased but not promoted;
group B: an item purchased and promoted;
group C: an item not purchased nor promoted; and
group D: an item not purchased but promoted.

Note that group A corresponds to class 1, group B corresponds to a mixture of class 1 and class 2, group C corresponds to a mixture of class 2 and class 3, and group D corresponds to class 3.

The order of the user's preference is class 1>class 2>class 3; thus, the order of preference of the individual groups is, on the average,

group A>group B>group C>group D.

Here, an item with a high promotion effect belongs to class 2 where whether the item is purchased or not may be determined by whether the item is promoted or not, and the order of preference among class 2, group B, and group C is:

group B>class 2>group C.

Thus, as an item with a high promotion effect, an item that is less than or equal to group B and greater than or equal to group C may be extracted as an item to be recommended. In other words, an item that is less than or equal to group B and greater than or equal to group C is an item predicted to be not purchased if not promoted but be purchased if promoted.

FIG. 3 schematically illustrates a grouping process performed by the comparative preference grouping unit 16. The comparative preference grouping unit 16 classifies, using the item purchase histories stored in the user purchase history DB 12 and the item promotion histories stored in the item promotion history DB 14, each item into one of the four groups A to D for each user.

For example, as illustrated in FIG. 3, if the presence or absence of purchase and the presence or absence of promotion of items with the item IDs=1 to 6 for a user identified by the user ID=1 is as below:
item ID=1: not purchased, not promoted;
item ID=2: purchased, promoted;
item ID=3: not purchased, not promoted;
item ID=4: purchased, not promoted;
item ID=5: not purchased, promoted; and
item ID=6: not purchased, not promoted,
   then, because items with the item IDs=1, 3, and 6 are all “not purchased, not promoted”, these items are classified into group C. In addition, because an item with the item ID=2 is “purchased, promoted”, this item is classified into group B. In addition, because an item with the item ID=4 is “purchased, not promoted”, this item is classified into group A. Furthermore, because an item with the item ID=5 is “not purchased, promoted”, this item is classified into group D.

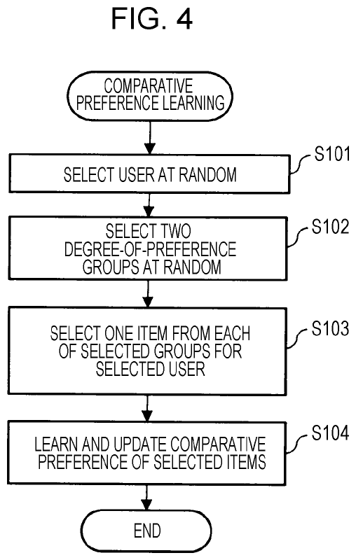

FIG. 4 is a flowchart of a learning process performed by the comparative preference learning unit 18. The comparative preference learning unit 18 calculates the degree of comparative preference for items using the four groups A to D into which classification is done by the comparative preference grouping unit 16.

At first, the comparative preference learning unit 18 selects a user at random (S101). For example, the comparative preference learning unit 18 selects a user with the user ID=1.

Next, the comparative preference learning unit 18 selects two groups from among the four groups A to D at random (S102). For example, the comparative preference learning unit 18 selects group B and group C.

Next, the comparative preference learning unit 18 selects one item from each of the two groups selected in step S102 for the user selected in step S101 (S103). For example, the comparative preference learning unit 18 selects an item with the item ID=2 from group B, and selects an item with the item ID=6 from group C.

The comparative preference learning unit 18 learns and updates comparative preference of the selected items (S104). The learning is executed as follows.

That is, if the strength of preference of a certain user u for item i is a preference score, then the preference score may be calculated from a feature of an item and a feature of an item that this user u likes. Specifically, if vector qᵢ is a feature of an item and vector pᵤ is a feature of an item that user u likes, then the preference score is expressed as the inner product of the two vectors as:

preference score νᵤᵢ=qᵢ^{T}pᵤ.

A feature of an item may be made into a vector from the viewpoint of, for example, genre, price, and purchasers. Genre, price, and purchasers are represented by numerals as follows to make a feature of an item into a vector:

qi=(a,b,c)

Here, a is a numeral that defines the genre, b is a numeral that defines the price, and c is a numeral that defines the purchasers. The genre may be represented by the number of divisions according to the classification of products under a trademark law; the price may be represented by the number of divisions such as about six; and the purchasers may be represented by the number of divisions corresponding to a combination of age, occupation, and gender. Alternatively, a feature of each item may be expressed as an implicit latent feature using a technique such as matrix factorization, without explicitly defining the feature. (Non-patent literature: Yehuda Koren, Robert Bell, and Chris Volinsky. 2009. Matrix Factorization Techniques for Recommender Systems. Computer 42, 8 (August 2009), 30-37).

At this time, the difference in preference of user u between item i and item j is expressed as:

xᵤᵢⱼ=νᵤᵢ−νᵤⱼ.

Using this difference xᵤᵢⱼ in preference of user u between item i and item j, the probability of user u preferring item i to item j is calculated. Given α and β as two groups with different comparative preferences, let a be group A and β be group B, for example. If it is assumed that item i belongs to group α and item j belongs to group β, then the probability of user u preferring item i to item j is expressed using a sigmoid function:

$$p ( i ∈ {I}_{u}^{α} \hat{} j ∈ {I}_{u}^{β} ) = \frac{1}{( 1 + {e}^{- {x}_{uij}} )} .$$

A model parameter Θ of the difference xᵤᵢⱼ in preference of user u is sequentially updated and learned so that the preference probability becomes maximum. That is, the parameter Θ is updated and learned by:

$$Θ ← Θ + α ( \frac{{e}^{- {x}_{uij}}}{1 + {e}^{- {x}_{uij}}} \cdot \frac{\partial }{\partial Θ} {x}_{uij} - {λ}_{Θ} Θ ) .$$

The processing in steps S101 to S104 is repeatedly executed until the learning converges. Using the parameter Θ obtained by the learning, the preference score νᵤᵢ of user u for item i is calculated.

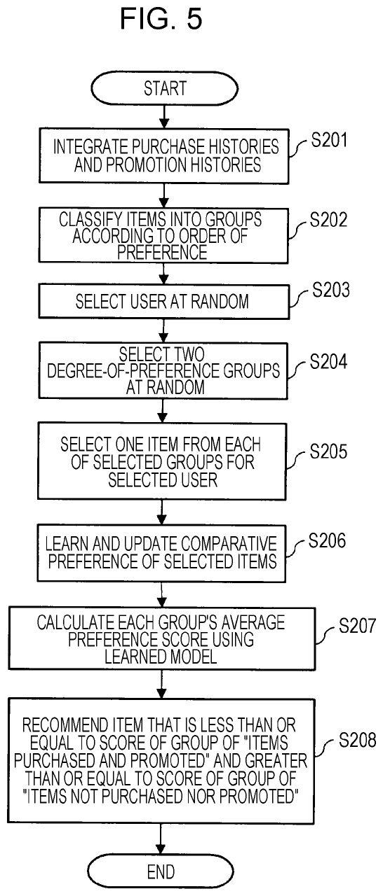

FIG. 5 is a flowchart of an overall process according to the present exemplary embodiment.

At first, the comparative preference grouping unit 16 accesses the user purchase history DB 12 and the item promotion history DB 14 to integrate the user purchase histories and the item promotion histories (S201). The table illustrated in FIG. 3 is generated by integrating the user purchase histories and the item promotion histories in this manner.

Next, the comparative preference grouping unit 16 classifies items into four groups according to the order of preference for the items using the integrated data (S202). That is, the items are classified into the following four groups in descending order of preference:
group A: an item purchased but not promoted;
group B: an item purchased and promoted;
group C: an item not purchased nor promoted; and
group D: an item not purchased but promoted.

Next, the comparative preference learning unit 18 learns the comparative preference of items selected in accordance with the flowchart of the process illustrated in FIG. 4. That is, the comparative preference learning unit 18 selects a user at random (S203), and selects two groups from among the four groups A to D at random (S204). The comparative preference learning unit 18 selects one item, at random, from each of the selected two groups for the selected user (S205), and learns and updates comparative preference of the selected two items using the above equation (S206). The processing in steps S203 to S206 is repeatedly executed until the learning converges.

After the learning has ended, the average score calculating unit 20 calculates the average preference score of each group for each user using the learned model, that is, the learned parameter Θ (S207). For example, the average score calculating unit 20 calculates the preference score of an item with the item ID=4 belonging to group A for a user with the user ID=1 as below:

preference score νᵤᵢ=qᵢ^{T}pᵤ.

The average score calculating unit 20 calculates the preference score of all the items belonging to group A, and calculates the average of these preference scores to calculate the average preference score of group A. The same applies to the other groups B to D.

After the average preference score of each group has been calculated, the item recommending unit 22 extracts an item satisfying a specified score condition as an item to be recommended to the user (S208). The specified score condition is a condition for extracting an item that is less than or equal to group B, which includes “items purchased and promoted”, and greater than or equal to group C, which includes “items not purchased nor promoted”. Specifically, if νb is the average preference score of group B, which is calculated in step S207, and νc is the average preference score of group C, then the specified score condition is:

νb≥ν≥νc.

Therefore, the preference score of a certain item is calculated, and, if that preference score satisfies the above-described condition, that item is presented as an item to be recommended to the user; and, if the calculated preference score does not satisfy the above-described condition, that item is not presented as an item to be recommended. Because the average preference score of each group is calculated for each user and whether or not the above-described condition is satisfied is determined for each user, the same item may be presented as an item to be recommended to a certain user, but may not presented as an item to be recommended to another user.

A target to which the present exemplary embodiment is applied includes, for example, the sale of a new product of a company. In the case of determining to which user group this new product is to be promoted, the technology of the present exemplary embodiment may be used. That is, the preference score is calculated for the new product, and a user group whose preference score satisfies the above-condition is extracted. The new product is promoted to the extracted user group. This means that not only the item is output as an item to be recommended, but also to which user group the item is recommended is output. In the case of outputting the user group, the user group may be output in combination with collaborative filtering, which is one technique of the related art. That is, in the case where a plurality of users to which the item is to be recommended are extracted, another user group having similar purchasing tendencies with these users is extracted by collaborative filtering.

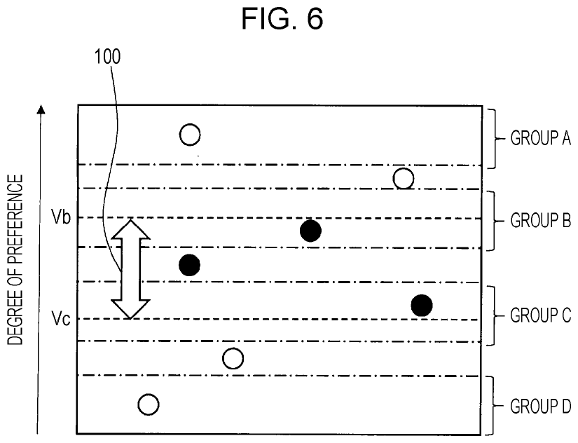

FIG. 6 illustrates the relationship between each group's preference score (degree of preference) and items to be recommended. In FIG. 6, areas indicated by dashed lines correspond to groups A to D, and their preference scores are in the following relationship:

group A>group B>group C>group D.

The average preference score νb of group B and the preference score νc of group C are indicated by broken lines. A range whose upper limit and lower limit are determined by these average scores (a range indicated by an arrow 100 in FIG. 6) is a specified condition range. An item within this range is output as an item to be recommended (indicated by a black circle in FIG. 6), and an item outside this range is not output as an item to be recommended (indicated by a white circle in FIG. 6). This is, so to speak, an item with an intermediate degree of preference is output as an item to be recommended.

There has been technology for recommending an item with the maximum difference in purchase rate between the case in which the item is recommended and the case in which the item is not recommended. If the purchase rates of all items with and without recommendations are to be learned, the calculation cost increases. Prediction errors of a recommended item and an unrecommended item, that is, an error between the predicted purchase rate and the actual purchase rate of a recommended item and an error between the predicted purchase rate and the actual purchase rate of an unrecommended item, are both equally treated and learned, the accuracy of a recommended item may be insufficient due to the influence of an unrecommended item. In the present exemplary embodiment, after items are classified into the four groups, it is configurated to extract an item whose preference is lower than the group of “items purchased and promoted” but higher than the group of “items not purchased nor promoted”. Thus, an item to be recommended to each user may be presented with higher efficiency and accuracy than before.

In the present exemplary embodiment, it is preferable to send, as a feedback to the product recommending apparatus 10, the result that whether the item has been purchased in the case where the item is recommended to the user in step S208, and to adjust the average preference score of each of groups A to D.

Although the exemplary embodiment of the present disclosure has been described as above, the present disclosure is not construed to be limited to the exemplary embodiment, and various modifications may be made. Hereinafter, modifications will be described.

### First Modification

Although the average preference score is calculated for each group in the exemplary embodiment, the minimum preference score νb min of group B and the maximum preference score νc max of group C may be calculated, and, in the case where an item's preference score is within the range of the minimum preference score νb min of group B and the maximum preference score νc max of group C, the item may be extracted as an item to be recommended. That is, the item may be regarded as an item to be recommended in the case of the following:

νb min≥ν≥νc max.

### Second Modification

In the exemplary embodiment, the preference score is calculated as below:

preference score νᵤᵢ=qᵢ^{T}pᵤ.

However, this is only one example, and other evaluation equations may be used. In short, it is only necessary to quantify the degree of preference according to each of the four groups with different degrees of preference, and to extract an item whose degree of preference is between the degree of preference of group B and the degree of preference of group C as an item to be recommended.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A product recommending apparatus comprising:
an obtaining unit that obtains a purchase history indicating information on a product that a user has purchased, and a promotion history indicating information on a product promoted to a user;
a classification unit that classifies, using the purchase history and the promotion history, each product into one of a first group of items purchased but not promoted, a second group of items purchased and promoted, a third group of items not purchased nor promoted, and a fourth group of items not purchased but promoted; and
a controller that outputs, using a result of classification done by the classification unit, an item that is not purchased if not promoted but is purchased if promoted as an item to be recommended to a user.

2. The product recommending apparatus according to claim 1, wherein the controller calculates a preference score of the first group, the second group, the third group, and the fourth group for each user, and outputs the item to be recommended using the preference scores.

3. The product recommending apparatus according to claim 2, wherein the controller outputs a product whose preference score is less than or equal to the preference score of the second group and greater than or equal to the preference score of the third group as the item to be recommended.

4. The product recommending apparatus according to claim 2, wherein the controller outputs a product whose average preference score is less than or equal to an average preference score of the second group and greater than or equal to an average preference score of the third group as the item to be recommended.

5. The product recommending apparatus according to claim 2, wherein the controller selects two groups from among the first group, the second group, the third group, and the fourth group, selects one item from each of the selected two groups, and learns comparative preference of the selected two items, thereby calculating the preference score.

6. The product recommending apparatus according to claim 2, wherein, if qᵢ is a feature vector of a product and pᵤ if a feature vector of a product that a user likes, then the controller calculates the preference score using:
νᵤᵢ=qᵢ^{T}pᵤ.

7. A non-transitory computer readable medium storing a program causing a computer to execute a process, the process comprising:
obtaining a purchase history indicating information on a product that a user has purchased, and a promotion history indicating information on a product promoted to a user;
classifying, using the purchase history and the promotion history, each product into one of a first group of items purchased but not promoted, a second group of items purchased and promoted, a third group of items not purchased nor promoted, and a fourth group of items not purchased but promoted; and
outputting, using a result of classification, an item that is not purchased if not promoted but is purchased if promoted as an item to be recommended to a user.

8. A product recommending apparatus comprising:
obtaining means for obtaining a purchase history indicating information on a product that a user has purchased, and a promotion history indicating information on a product promoted to a user;
classification means for classifying, using the purchase history and the promotion history, each product into one of a first group of items purchased but not promoted, a second group of items purchased and promoted, a third group of items not purchased nor promoted, and a fourth group of items not purchased but promoted; and
control means for outputting, using a result of classification done by the classification means, an item that is not purchased if not promoted but is purchased if promoted as an item to be recommended to a user.
